(19) United States
(12) Patent Application Publication
(10) Pub. No.: US 2016/0106064 A1
(43) Pub. Date: Apr. 21, 2016

(54) TAG APPLICATOR

(71) Applicant: DATAMARS SA, Bedano-Lugano (CH)

(72) Inventors: Roy Victor BLADEN, Albany, Auckland (NZ); Michael Stuart GARDNER, Remuera, Auckland (NZ)

(73) Assignee: DATAMARS SA, Bedano-Lugano (CH)

(21) Appl. No.: 14/890,339

(22) PCT Filed: May 9, 2014
(86) PCT No.: PCT/NZ2014/000085

§ 371 Date: Nov. 10, 2015

(30) Foreign Application Priority Data
May 10, 2013 (NZ) 610503

(51) Int. Cl. A01K 11/00

(52) U.S. Cl. CPC A01K 11/002

(57) ABSTRACT

There is provided a tag applicator (1) for a wrap around tag (12) which includes first and second pivotally connected jaws (4, 5) which are moveable together when applying the tag. The first jaw (5) includes a pin (6) adapted to receive a male portion (13, 16) of the tag, and the second jaw (4) is adapted to receive a female portion (15) of the tag. One of the jaws includes a guide means (11) adapted to act on a loop portion (14) of the tag (12) connecting the male and female tag portions. The guides means biases the male and female portions of the tag apart prior to engaging these together apart an animal's ear.

### TECHNICAL FIELD

The present disclosure relates to a tag applicator and more particularly to a cattle tag applicator.

### BACKGROUND OF THE INVENTION

Identification tags are typically applied towards the mid part or edge of the animal's ear i.e. distant from the animal's head, where they can be frequently snagged on trees, fences and other obstacles.

Loop or wrap-around one-piece tags may also interfere with the growth of the animal's ear if they do not leave sufficient space when applied.

### SUMMARY OF THE INVENTION

It is an object of at least one embodiment of the invention to provide a tag applicator which overcomes or at least alleviates problems in the prior art at the present time or which at least will provide the public with a useful choice.

Further objections of the invention, all objects being considered disjunctively, may be apparent from the following description.

According to one aspect there is provided a tag applicator for a wrap around tag including first and second pivotally connected jaws moveable together when applying a tag, said first jaw including a pin adapted to receive a male portion of the tag and said second jaw adapted to receive a female portion of the tag, at least one of said jaws including a guide means adapted to position the tag between the jaws so that when the male and female tag portions are engaged together about an animal's ear, a loop portion of the tag, connecting the male and female tag portions, provides a required spacing around the animal's ear.

Preferably the guide means includes at least one profiled surface of said second jaw.

According to a second aspect there is provided a tag applicator includes first and second pivotally connected jaws, said first jaw having a pin connected thereto and adapted to receive a male portion of a tag, said second jaw having an upper surface adapted to receive a female portion of the tag, said upper surface defining a plane, and said pin, as it moves the male portion, in use, to engage the female tag, being at an inward angle away from the vertical relative to said plane.

Preferably the said angle is between approximately 5° and 10° to the vertical.

Preferably the pin is pivotally connected with said first jaw.

According to a further aspect there is provided a tag applicator substantially as herein described with reference to the accompanying drawings.

According to another aspect there is provided a tag applicator having first and second pivotally connected jaws moveable together when applying a tag. The first jaw includes a pin adapted to receive a male portion of the tag, and the second jaw is adapted to receive a female portion of the tag. The pin is pivotally connected to the first jaw.

Advantageously this arrangement allows the pin to move with respect to the tagger in order to more easily release the male part of the tag. This can be useful when tagging at the upper and thicker part of the animal's ear which typically requires a longer pin. Allowing the pin to move with respect to the first jaw helps prevent injury to a farmer using the tag should the animal move its head during the tagging operation. The moveable pin allows the male part of the tag to be more easily released thereby preventing jarring to the user of the tagger.

In an embodiment the pin is moveable between a line along its longitudinal axis to the second jaw, and an outward angle away from the line. The pin is biased away from the outward angle towards the line. The biasing of the pin ensures that the tag is normally properly aligned for the tagging operation, but does allow for movement of the pin to release the male part of the tag following tagging and should the animal move its head. In an embodiment one of the jaws includes a guide means such as an abutment adapted to act on a loop portion of the tag which connects the male and female tag portion.

The guide means is adapted to bias the male and female portions of the tag apart prior to engagement about an animal's ear. This facilitates the tagging operation by ensuring a wider gap between the male and female parts of the tag portion when moving the tagger over an animal's ear. The guide means may also comprise a profiled surface which corresponds to a longitudinal depth within the jaws for receiving the animal's ear in order to indicate a predetermined spacing between an edge of the animal's ear and the loop portion of the tag. Thus a user of the tagger can position the tagger over the animal's ear and use the guide means to determine how far the tagger should be pushed over the ear in order to maintain sufficient space between the ear and the tag loop. The gap required may depend on the age of the animal, for example a larger gap may be required for a growing calf compared to a mature cow.

In an embodiment the jaws are arranged to move under the action of a biasing means to an open position following application of the tag. This further facilitates quick and easy release of the tag parts following completion of the tagging operation. The embodiment may include an arrangement in which first and second handle portions are arranged such that movement together will cause the movement together of the first and second jaws. A linkage means is provided between one of the handle portions and one of the jaws which, in a first position, enables the movement of one jaw towards the other upon movement of the handle portions together but, in a second position, enables the one jaw portion to be released from its open position.

In another aspect there is provided a tag applicator for a wrap around tag including first and second pivotally connected jaws moveable together when applying a tag. The first jaw includes a pin adapted to receive a male portion of the tag and the second jaw adapted to receive a female portion of the tag. A guide means is provided which is adapted to act on a loop portion of the tag connecting the male and female tag portions. The guide means biases the male and female portions of the tag apart prior to engaging about an animal's ear.

Embodiments of this aspect may be provided with or without the pivotally connected pin, and may include the various features noted above with respect to the pivotable pin aspect.

Further aspects, which should be considered in all its novel aspects, will become apparent from the following description, given by way of example of possible embodiments and with reference to the accompanying drawings.

### BRIEF DESCRIPTION OF THE DRAWINGS

FIG. 1: shows a side view of a tag applicator according to one possible embodiment of the invention;

FIG. 2: shows a plan view of FIG. 1;

FIG. 3: shows a front view of FIG. 1;

FIG. 4: shows the tag applicator of FIG. 1 in its jaw-closed position;

FIG. 5: shows diagrammatically the front part of the tag applicator of FIG. 1 in its jaw-open position, and including a wrap around tag positioned between its jaws; and

FIG. 6: shows very diagrammatically the applicator of FIG. 5 about to tag an animal's ear adjacent to its head.

### DESCRIPTION OF ONE POSSIBLE EMBODIMENT

Referring to the accompanying drawings, a tag applicator according to one possible embodiment of the invention is referenced by arrow 1. It is shown with handle portions 2 and 3 extending to respective jaws 4 and 5, with a pivot 9 to allow for the jaws to close together. The applicator 1 in this particular example is shown with a toggle linkage 10. For further details of such an applicator 1 reference should be made to our New Zealand patent specification 582984 where it is described how an over-centre toggle linkage can result in the jaws 4 and 5 springing open following the tagging operation. The present invention could however be used with any other suitable tag applicator.

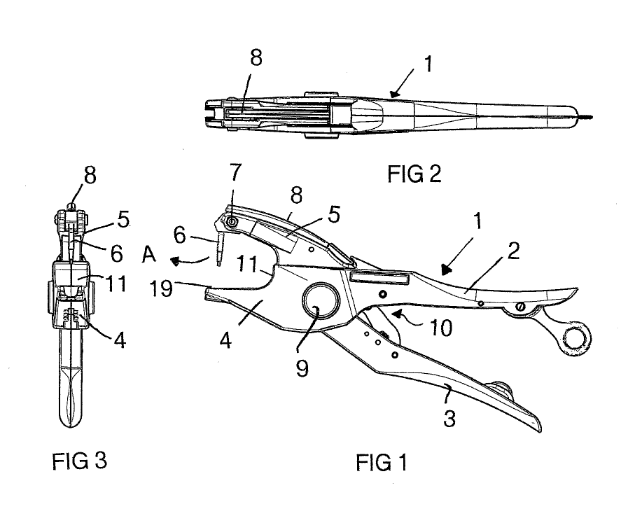

The top jaw 5 is shown with an elongate pin 6 pivoted on a pivot, such as a pin, 7. A spring bias 8, in this example, biases the pin 6 towards its downward position, as shown in FIG. 1, although allowing the pin 6 to pivot outwardly in a direction indicated by arrow A at the end of a tagging operation. The lower jaw 4 is shown with an upper surface 19 adapted to accommodate a female portion of an identification tag, and an interior surface 11 is shown arcuately extending upwardly towards the upper jaw 5.

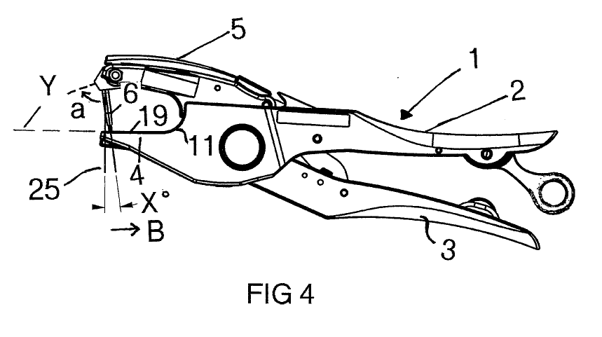

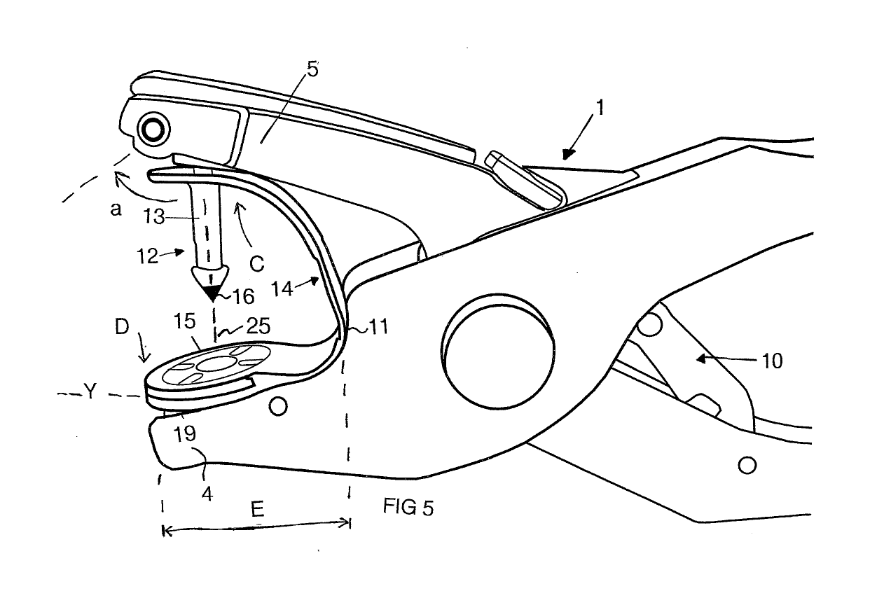

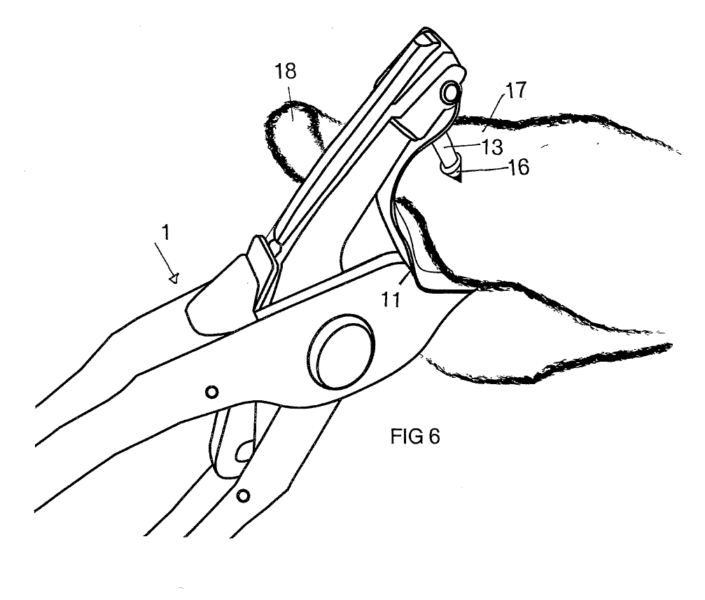

Referring particularly to FIG. 4 the jaws 4 and 5 are shown in their closed position with the end of the pin 6 now at, or adjacent, the upper surface 19 of the lower jaw 4 on which, in use, the female tag portion would be positioned (see FIG. 5). The plane of the upper surface 19 is illustrated diagrammatically and referenced Y and the angle to the vertical relative to that plane Y of the pin 6 is shown as X° . Preferably this angle X° will be between approximately 5° and approximately 10° . Referring to FIG. 5 it is seen that a wrap around tag 12 has a male portion 13 having a head 16 with a hard tip forming part of its head. The male portion 13 is connected by a flexible loop portion 14 with a female tag portion 15 suitably including an RFID component. The female tag portion 15 is shown positioned on top of the upper surface 19 of the lower jaw 4 so that the plane of the upper surface of the female tag 15 will essentially correspond with the plane of the upper surface 19. The interior surface 11 of the lower jaw 4 is shown providing an abutment for the loop portion 14 of the tag 12, thus ensuring its correct positioning between the jaws 4 and 5 following its insertion. The surface 11 also acts as a guide and ensures that the loop portion 14 defines an appropriate shape such that when the male and female tag portions 13 and 15 are engaged together about the animal's ear, a suitable gap will be provided around the ear to enable it to grow as well as allowing movement of the tag about the ear.

Although the surface 11 is shown as an integral inner part of the lower jaw 4, it could instead or additionally, form part of the upper jaw 5 or be a discrete guide member.

Referring then to FIG. 6 the male tag portion 13, with its hard-tipped head 16, is shown being applied to the ear 17 of an animal adjacent its head 18 so as to be on the thickest part of the animal's ear where it will be less likely to snag, avoiding ripped ears and lost tags. To facilitate this, the stem of the male tag portion 13 is suitably much longer than in normal cattle tags.

Reference may be made to our Australian patent specification 2013100620, or New Zealand patent specification number 603684, for a further description of such an elongated-stem cattle tag.

Returning now to FIG. 4 the inward angling of the pin 6 relative to a vertical axis perpendicular to the plane of the upper surface 19 of the lower jaw 4, will facilitate the ease of entry of the male tag into and through the animal's ear, while still allowing the pin 6 to freely flick-out or pivot, in the direction indicated by Arrow A in FIG. 1, once the tagging operation has been completed. The angle of entry will also facilitate the engagement of the head portion 16 into and through the aperture provided in the female tag portion 15.

Referring particularly to FIG. 5, a line 25 along the longitudinal axis of the pin 6 (and male parts 13, 16 of the fitted tag 12) to the second jaw 4 is shown. The line 25 may be perpendicular to the plane of the jaw 4 as shown, or may be angled inwardly in direction B shown in FIG. 4. The pin 6 is moveable between the line 25 and an outward angle a away from the line as indicated in FIGS. 4 and 5. However as described above, the pin is biased towards the line which corresponds to the normal alignment of male and female parts of the tag for engagement. Once the male and female parts of the tag are engaged about an animal's ear, the female part will tend to disengage from the lower jaw 4 and the male part of the tag 12 will then slip off the pin 6. This release from the pin 6 is facilitated by the ability of the pin to flick out in the direction A. This also reduces injury to a user of the tagger should the cow or other animal suddenly move its head during the tagging operation. By allowing the pin to pivot with respect to the tagger jaws, the tagger held by the user is not so violently moved thereby reducing injury.

The guide means or abutment 11 acts on the loop portion 14 of the wrap around tag 12 by pushing the male part of the tag 13 upwards onto the pin 6. This effectively opens the gap between the male and female parts of the tag to allow easier tagging, particularly at the upper or head end of an ear which is thicker. Thus the female part 15 is biased in direction D on the lower jaw 4 whereas the male part 13 is biased in direction C towards the upper jaw 5 in order to maximise the gap between them. The abutment also acts as a guide to a user of the tagger, and corresponds to a maximum longitudinal depth E between the jaws within which an animal's ear is received. By adjusting the gap between the abutment 11 and loop 14, a corresponding gap is left between the edge of the animal's ear and the loop 14 once the female and male parts have been engaged. A relatively small gap may be desired for mature animals, however, a larger gap may be left for juvenile animals such as calf's to allow for growth of the ear within the gap provided.

In an embodiment for use on the head end or thicker portions of an animal's ear, a longer pin is required. In one arrangement the ratio of the length of the stem portion 13 to the length of the head portion 16 of the male tag part 12 is at least 2.6. This may be usefully combined with the other above described features of the tagger.

Where in the foregoing description reference has been made to specific components or integers of the invention having known equivalents then such equivalents are herein incorporated as if individually set forth.

Although this invention has been described by way of example and with reference to possible embodiments thereof it is to be understood that modification or improvements may be made thereto without the departing from the scope of the invention.

1. A tag applicator for a wraparound tag including:
first and second pivotally connected jaws moveable together when applying a tag, said first jaw including a pin adapted to receive a male portion of the tag and said second jaw adapted to receive a female portion of the tag,
at least one of said jaws including a guide means adapted to act on a loop portion of the tag connecting the male and female tag portions, in order to bias apart the male and female portions of the tag prior to engaging the male and female tag portions together about an animal's ear and where the male portion and the female portion of the tag are connected by a flexible loop portion.

2. A tag applicator according to claim 1 , wherein the guide means comprises a profiled surface of the second jaw which in use corresponds to a longitudinal depth between the jaws within which to receive an animal's ear in order to provide a predetermined spacing between an edge of the animal's ear and the loop portion.

3. A tag applicator according to claim 1, wherein the pin is pivotally connected with said first jaw.

4. A tag applicator according to claim 3, wherein the pin is movable between a line along its longitudinal axis to the second jaw and an outward angle away from said line, the pin being biased away from the outward angle towards said line.

5. A tag applicator according to claim 4, wherein the pin is further biased to an inward angle away from said line.

6. A tag applicator according to claim 1, wherein said jaws are arranged to move under the action of a biasing means to an open position following application of the tag.

7. A tag applicator according to claim 6, further comprising:
first and second handle portions arranged such that movement together will cause the movement together of the first and second jaws;
a linkage means provided between one of said handle portions and one of said jaws which, in a first position, enables the movement of said one jaw towards the other said jaw upon the movement of the handle portions together but, in a second position, enables the said one jaw portion to be released into its open position.
